(19) United States
(12) Patent Application Publication
(10) Pub. No.: US 2026/0246170 A1
(43) Pub. Date: Aug. 20, 2026

(54) BUS BAR UNIT

(71) Applicant: Yazaki Corporation, Tokyo (JP)

(72) Inventors: Yuuhei Takeshita, Makinohara-shi (JP); Koki Iwakura, Makinohara-shi (JP); Moeto Osawa, Fujieda-shi (JP); Masayuki Ishigami, Fujieda-shi (JP)

(21) Appl. No.: 19/541,233

(22) Filed: Feb. 16, 2026

(30) Foreign Application Priority Data
Feb. 19, 2025 (JP) 2025-025114

(51) Int. Cl. H01R 11/01; H01R 9/18; H01R 9/22; H02G 5/04

(52) U.S. Cl. CPC H01R 11/01; H01R 9/18; H01R 9/226; H02G 5/04

(57) ABSTRACT

A bus bar unit includes a terminal block and a bus bar provided integrally with the terminal block. The bus bar has a first portion extending from the terminal block in a first direction, a curved portion connected to an end portion of the first portion on a side opposite to the terminal block, and a second portion extending from the curved portion to a first side in a second direction intersecting the first direction and in which a bolt fastening hole is formed. The curved portion is formed in a curved shape protruding toward a second side in the second direction with respect to the first portion.

### BACKGROUND OF THE INVENTION

### Field of the Invention

Embodiments of the present invention relate to a bus bar unit.

Priority is claimed on Japanese Patent Application No. 2025-025114 filed in Japan on February 19, 2025, the content of which is incorporated herein by reference.

### DESCRIPTION OF RELATED ART

Patent Document 1 described below discloses a bus bar unit including a bus bar and a connector unit formed so as to be integrated with the bus bar by insert molding. The bus bar has an L-shaped portion protruding from the connector unit. The L-shaped portion of this bus bar has an end portion in which a bolt insertion hole through which a fastening bolt is inserted is formed.

### Prior Art Document

### Patent Document

Patent Document 1: Japanese Unexamined Patent Application, First Publication No. 2024-44723

### SUMMARY OF THE INVENTION

However, in the bus bar unit of Patent Document 1, when bolt fastening is performed in a state where there is a gap between the bus bar and a counterpart fastening object, the bus bar deforms so as to fill this gap, and stress concentrates in the L-shaped curved portion. There has been a concern that the strength of the bus bar may decrease due to this stress concentration.

One embodiment provides a bus bar unit that suppresses strength reduction of a bus bar due to stress concentration at the time of bolt fastening.

In one embodiment, a bus bar unit includes a terminal block and a bus bar provided integrally with the terminal block, in which the bus bar has a first portion extending from the terminal block in a first direction, a curved portion connected to an end portion of the first portion on a side opposite to the terminal block, and a second portion extending from the curved portion to a first side in a second direction intersecting the first direction and in which a bolt fastening hole is formed, and the curved portion is formed in a curved shape protruding toward a second side in the second direction with respect to the first portion.

According to one embodiment, it is possible to suppress strength reduction of a bus bar due to stress concentration at the time of bolt fastening.

### BRIEF DESCRIPTION OF THE DRAWINGS

FIG. 1 is a perspective view showing a bus bar unit of an embodiment.

FIG. 2 is a front view showing the bus bar unit of the embodiment.

FIG. 3 is a side view showing a bus bar of the embodiment.

FIG. 4 is a front view showing the bus bar of the embodiment.

FIG. 5 is a view showing, from a side, a state of deformation of the bus bar at the time of bolt fastening in the embodiment.

FIG. 6 is a view showing, from the front, the state of deformation of the bus bar at the time of bolt fastening in the embodiment.

### DETAILED DESCRIPTION OF THE INVENTION

Hereinafter, an embodiment will be described with reference to the drawings. In the following description, configurations having the same or similar functions are denoted by the same reference numerals. Also, overlapping descriptions of those configurations may be omitted. Note that configurations described below do not limit the scope of the embodiments.

In the present disclosure, terms are defined as follows. “Connection” is not limited to mechanical connection and may include electrical connection. That is, “connection” is not limited to a case where two elements that are connection targets are directly connected and may include a case where two elements that are connection targets are connected with another element interposed therebetween. “Accommodation” is not limited to a case where an entire component is accommodated and may include a case where only a part of a component is accommodated (a state in which a remaining part of the component protrudes). “Covering” is not limited to a case of covering an entire target and may include a case of covering only a part of the target. “Orthogonal” and “the same” may respectively include cases of being “substantially orthogonal” and “substantially the same”. “Sheet-like” or “sheet” is not limited to a member having a thickness of 1 mm or more, and a member having a thickness of less than 1 mm (so-called film) may also correspond.

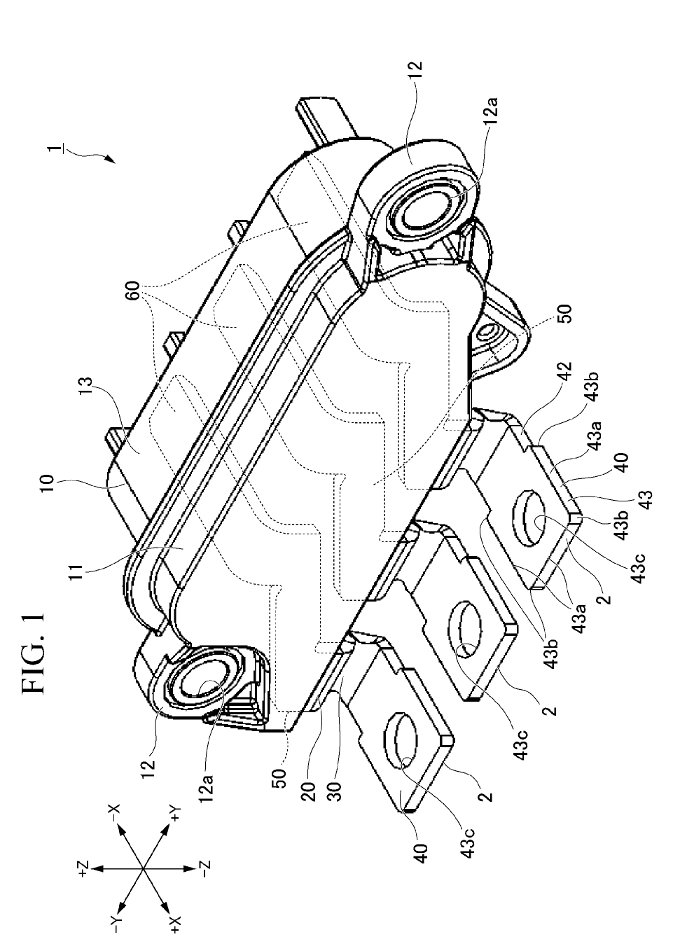

In the present disclosure, the +X direction, the -X direction, the +Y direction, the -Y direction, the +Z direction, and the -Z direction are defined as follows. As shown in FIG. 1, the X direction is one direction in a plane along a second portion 40 of a bus bar 2 described later. The +X direction is one direction among the X directions. The -X direction is a direction opposite to the +X direction. Hereinafter, when the +X direction and the -X direction are not distinguished, they are simply referred to as the “X direction”. The Y direction is a direction intersecting (for example, orthogonal to) the X direction in the plane along the second portion 40 of the bus bar 2 described later. The +Y direction is one direction among the Y directions. The -Y direction is a direction opposite to the +Y direction. Hereinafter, when the +Y direction and the -Y direction are not distinguished, they are simply referred to as the “Y direction”. The +Z direction and the -Z direction are directions intersecting (for example, orthogonal to) the X direction and the Y direction. The +Z direction is a direction intersecting a plane along which the second portion 40 of the bus bar 2 described later extends. The -Z direction is a direction opposite to the +Z direction. Hereinafter, when the +Z direction and the -Z direction are not distinguished, they are simply referred to as the “Z direction”. The Z direction is an example of the “first direction”. The X direction is an example of the “second direction”. The +X direction side is an example of the “first side in the second direction”. The -X direction side is an example of the “second side in the second direction”. The Y direction is an example of the “third direction”.

Hereinafter, when the X direction and the Y direction are not distinguished, they may be referred to as “horizontal direction”. Hereinafter, the Z direction may be referred to as “vertical direction”. Also, hereinafter, the +Z direction side may be referred to as “upper”, and the -Z direction side may be referred to as “lower”. However, these expressions are expressions for convenience of explanation and do not limit the gravity direction of the bus bar unit 1 (installation posture of the bus bar unit 1).

### Embodiment

### 1. Configuration of Bus bar Unit

The bus bar unit 1 is attached to, for example, a power control unit mounted on a vehicle such as an electric vehicle (EV), a hybrid electric vehicle (HEV), or a plug-in hybrid electric vehicle (PHEV).

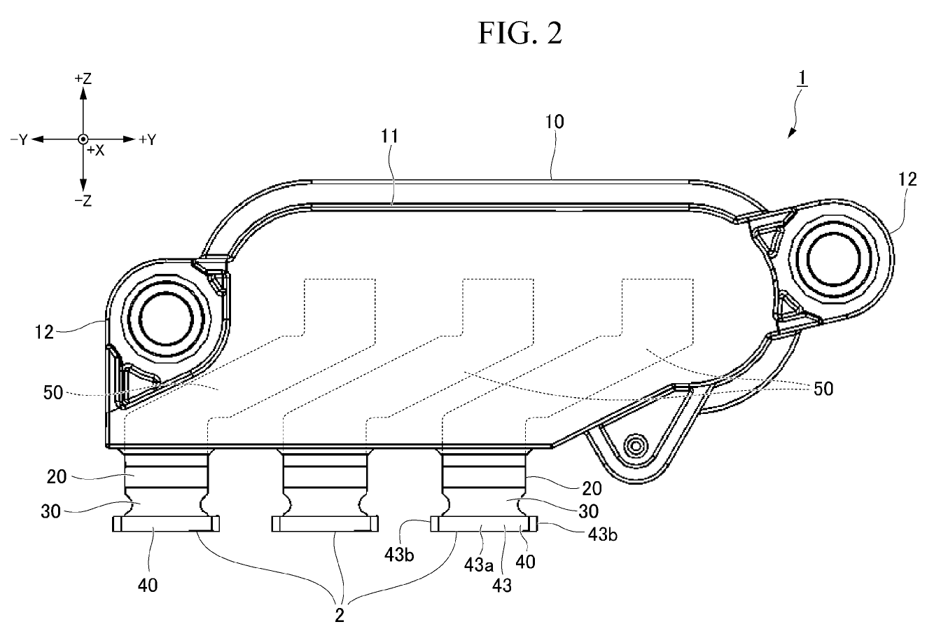

As shown in FIGS. 1 and 2, the bus bar unit 1 includes a terminal block 10 and a plurality of (three in the illustrated example) bus bars 2.

### Terminal Block

The terminal block 10 is formed so as to be integrated with the three bus bars 2 by, for example, insert molding. More specifically, the three bus bars 2 are inserted into an injection molding die, and molten resin is injected and poured around the three bus bars 2, whereby a resin-made terminal block 10 integrated with the inserted three bus bars 2 is molded. Note that this terminal block 10 is also referred to as a connector unit.

The terminal block 10 has a flange portion 11 and a side wall portion 13. The flange portion 11 is formed in a plate shape along the Y direction and the Z direction. Note that “plate-like” in the present disclosure is not limited to a case of being completely flat and may include a case where a protruding fixing structure, ribs, or the like partially exist. In the present embodiment, the flange portion 11 is formed so as to be long in the Y direction. A third portion 50 (described later) of the bus bar 2 is embedded in the flange portion 11. The flange portion 11 has fixing portions 12 at both end portions in the Y direction. Fastening holes 12a penetrating in the X direction are formed in the fixing portions 12. By inserting bolts through the fastening holes 12a, the terminal block 10 is fastened and fixed to, for example, a case (not shown) of a power control unit. The side wall portion 13 is formed in a cylindrical shape extending from the flange portion 11 in the -X direction. The side wall portion 13 is formed so as to surround a fourth portion 60 described later of the bus bar 2 in the Y direction. Also, the side wall portion 13 is formed so as to be long in the Y direction similarly to the flange portion 11.

### Bus bar

A plurality of (three in the present embodiment) bus bars 2 are provided. These three bus bars 2 are provided integrally with the terminal block 10. The three bus bars 2 are arranged side by side in the Y direction. The three bus bars 2 are flat plate-shaped members extending parallel to each other. The three bus bars 2 are all formed in the same shape. Each bus bar 2 has a first portion 20, a curved portion 30, a second portion 40, a third portion 50, and a fourth portion 60.

The first portion 20 extends from the terminal block 10 in the -Z direction. In the present embodiment, the first portion 20 extends in the -Z direction from a lower surface of the flange portion 11 facing in the -Z direction. The curved portion 30 is connected to an end portion of the first portion 20 on a side opposite to the terminal block 10 (an end portion of the first portion 20 on the -Z direction side). The second portion 40 extends from an end portion of the curved portion 30 on the -Z direction side toward the +X direction side. The third portion 50 extends from an end portion of the first portion 20 on the +Z direction side toward the +Z direction side. The third portion 50 is formed in a flat plate shape extending in the Y direction and the Z direction. The third portion 50 is inserted in the flange portion 11 of the terminal block 10. The third portion 50 is inclined so as to be positioned on the +Y direction side toward the +Z direction. The fourth portion 60 extends from an end portion of the third portion 50 on the +Z direction side in the -X direction. At least a part of the fourth portion 60 is accommodated in the side wall portion 13 of the terminal block 10. The fourth portion 60 is formed in a flat plate shape extending in the X direction and the Y direction. Also, the fourth portion 60 is formed so as to be long in the X direction.

### First Portion

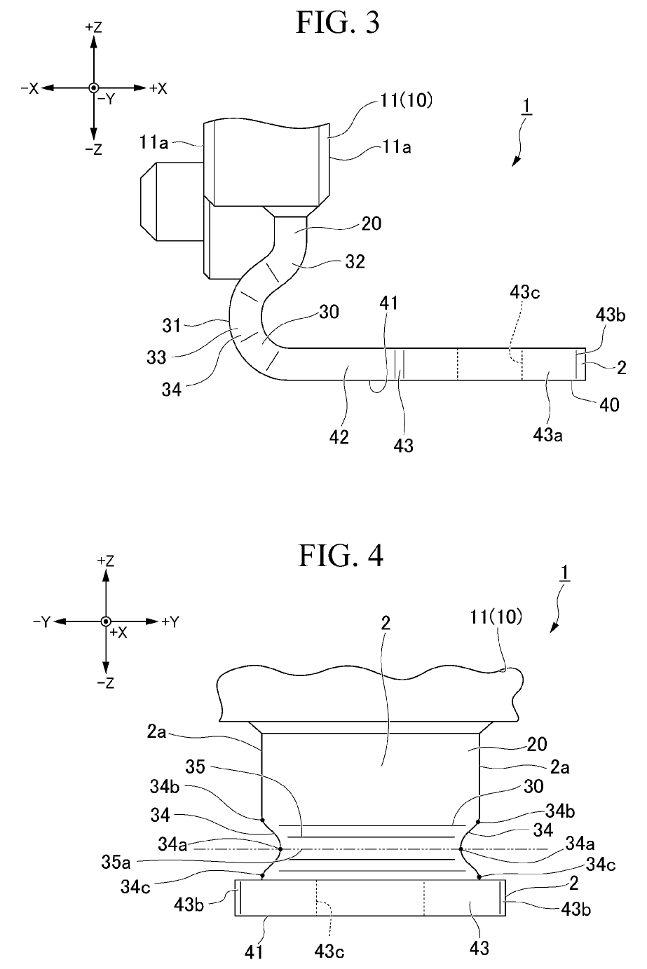

As shown in FIGS. 3 and 4, the first portion 20 extends from the lower surface of the flange portion 11 of the terminal block 10 toward the -Z direction side. The first portion 20 is formed in a flat plate shape extending in the Y direction and the Z direction. In the first portion 20, the width in the Y direction is equal over the entirety in the Z direction.

### Second Portion

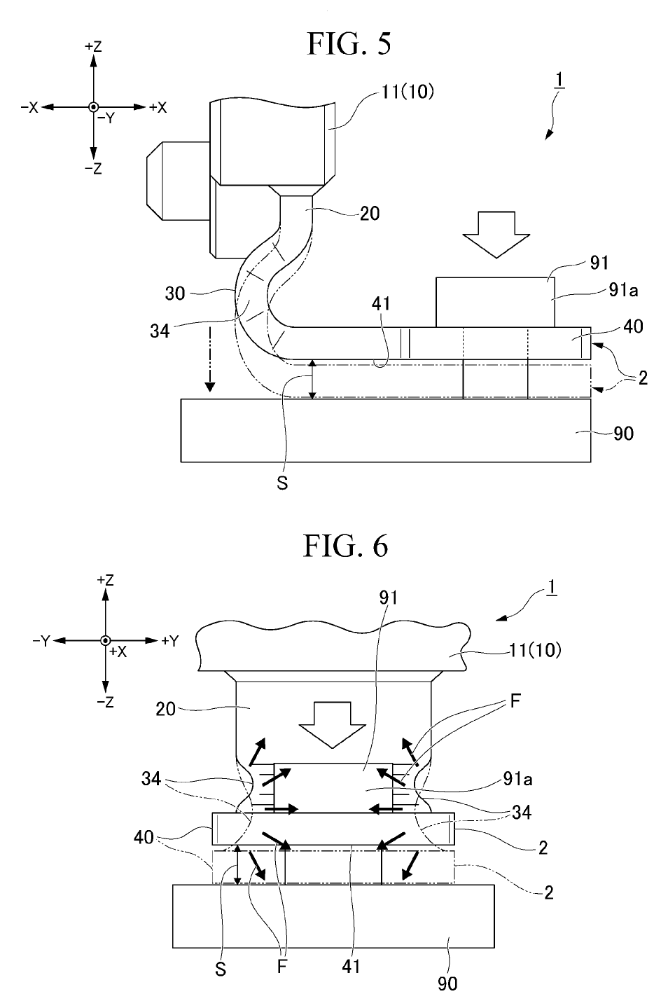

A bolt fastening hole 43c penetrating in the Z direction is formed in the second portion 40. The second portion 40 is formed in a flat plate shape extending in the X direction and the Y direction. The second portion 40 has a connection portion 42 and a fastening portion 43. The connection portion 42 connects the curved portion 30 and the fastening portion 43. The connection portion 42 extends from the curved portion 30 toward the +X direction side. The width of the connection portion 42 in the Y direction is equal to the width in the Y direction of an end portion of the curved portion 30 in the -Z direction. Also, in the connection portion 42, the width in the Y direction is equal over the entirety in the X direction. The fastening portion 43 is provided at an end portion of the connection portion 42 on the +X direction side. The width of the fastening portion 43 in the Y direction is larger than the width of the connection portion 42 in the Y direction. Edge portions 43a on both sides of the fastening portion 43 in the Y direction are positioned on an outer side in the Y direction than the connection portion 42. Also, in the fastening portion 43, the width in the Y direction is equal over the entirety in the X direction. Also, the fastening portion 43 is formed in a rectangular shape or a square shape extending in the X direction and the Y direction. When viewed from the Z direction, four corner portions 43b of the fastening portion 43 are formed in an arc shape protruding outward (see FIG. 1). These corner portions 43b are smoothly connected to each edge portion 43a of the fastening portion 43. Also, when viewed from the Z direction, at a central portion of the fastening portion 43, a bolt fastening hole 43c penetrating the fastening portion 43 in the Z direction is formed. A bolt 91 for fastening the bus bar 2 to a counterpart fastening object 90 is inserted through the bolt fastening hole 43c (see FIGS. 5 and 6).

### Curved Portion

The curved portion 30 is formed in a curved shape protruding toward the -X direction side with respect to the first portion 20. Also, the curved portion 30 is smoothly connected to the first portion 20 and the second portion 40. Also, a first surface 31 on the -X direction side of the curved portion 30 extends from a second surface 41 of the second portion 40 on the -Z direction side (a side opposite to the terminal block 10 in the Z direction) toward the +Z direction side (the terminal block 10 side in the Z direction). Note that the first surface 31 is a surface positioned on the most -X direction side in one bus bar 2. Also, the second surface 41 is a contact surface that contacts a counterpart fastening object 90 (see FIGS. 5 and 6) in one bus bar 2. The second surface 41 has a surface on the -Z direction side of the connection portion 42 and a surface on the -Z direction side of the fastening portion 43. Also, the curved portion 30 is formed so as to fit between end surfaces 11a on both sides of the flange portion 11 in the X direction when viewed in the Y direction.

The curved portion 30 has a bending starting portion 32 and a curved main body portion 33. The bending starting portion 32 is a portion of the curved portion 30 that is connected to the first portion 20. The bending starting portion 32 is curved so as to be positioned on the -X direction side while being away from the first portion 20 toward the Z direction (toward the -Z direction side). The curved main body portion 33 is smoothly connected to the bending starting portion 32 and extends from the bending starting portion 32 in the -Z direction. Also, the curved main body portion 33 is also smoothly connected to the second portion 40. The curved main body portion 33 is formed in a U-shape opening toward the +X direction side when viewed from the Y direction. Also, the curved main body portion 33 is curved in an arc shape protruding in the -X direction when viewed from the Y direction. Groove portions 34 having a curved shape when viewed from the X direction are formed at both end edges of the curved portion 30 in the Y direction.

### Groove Portion

The groove portions 34 are formed at both end edges of the curved main body portion 33 in the Y direction. The two groove portions 34 are formed in the same shape. Each groove portion 34 is formed in a U-shape when viewed from the X direction. The groove portions 34 are, for example, notched portions formed by notching the curved portion 30. Note that the groove portions 34 may be formed at the time of casting the bus bar 2. Also, here, assuming that portions of end surfaces on both sides of the bus bar 2 in the Y direction excluding the groove portions 34 are bus bar side surfaces 2a, the groove portions 34 are smoothly connected to the bus bar side surfaces 2a.

Also, here, with a center 34a of the groove portion 34 in the Z direction as a reference, the groove portion 34 is formed in a U-shape symmetrical in the Z direction. Also, the two groove portions 34 are formed such that the centers 34a of the two groove portions 34 are at the same position in the Z direction. Also, assuming that an end of the groove portion 34 on the +Z direction side is a first end 34b and an end of the groove portion 34 on the -Z direction side is a second end 34c, the two groove portions 34 are formed such that the first ends 34b and the second ends 34c are at the same positions in the Z direction.

Also, a portion of the curved portion 30 between the two groove portions 34 (a portion sandwiched by the two groove portions 34 in the Y direction) is referred to as a constricted portion 35. A width of the constricted portion 35 in the Y direction decreases from the first end 34b toward the center 34a and increases from the center 34a toward the second end 34c. A portion sandwiched by the centers 34a of the two groove portions 34 in the Y direction is a minimum width portion 35a which is a portion of the constricted portion 35 having the smallest width in the Y direction. This minimum width portion 35a is also a portion having the smallest width in the Y direction among the first portion 20, the curved portion 30, and the second portion 40. The constricted portion 35 is formed symmetrically in the Z direction with the minimum width portion 35a as a reference.

The width in the Y direction of a portion of the curved portion 30 excluding the groove portions 34 is equal to the width in the Y direction of the first portion 20. Also, the width in the Y direction of the portion of the curved portion 30 excluding the groove portions 34 is equal to the width in the Y direction of the connection portion 42 of the second portion 40.

Note that, before fastening the bus bar 2 to a counterpart fastening object 90 (see FIGS. 5 and 6), at least the first portion 20, the curved portion 30, and the second portion 40 of the bus bar 2 are formed with a uniform plate thickness.

### 2. Deformation at Time of Bus bar Fastening

Next, deformation of the bus bar 2 when fastening the bus bar 2 to a counterpart fastening object 90 will be described.

As shown in FIGS. 5 and 6, the second portion 40 of the bus bar 2 is disposed on the +Z direction side with respect to the counterpart fastening object 90. In that state, a bolt 91 is inserted through the bolt fastening hole 43c of the second portion 40 from the +Z direction side. At this time, if the second portion 40 and the fastening object 90 are separated in the Z direction, a head portion 91a of the bolt 91 is pressed against the second portion 40, and a force in the -Z direction is applied to the second portion 40. Due to this force applied in the -Z direction, the curved portion 30 of the bus bar 2 extends in the Z direction. Then, a surface (the second surface 41) of the second portion 40 facing in the -Z direction contacts the fastening object 90, and a gap S between the second portion 40 and the fastening object 90 is filled.

### 3. Advantages

In the present embodiment, the bus bar unit 1 includes the terminal block 10 and the bus bar 2. The bus bar 2 is provided integrally with the terminal block 10.

The bus bar 2 has the first portion 20, the curved portion 30, and the second portion 40. The first portion 20 extends from the terminal block 10 in the Z direction (first direction). The curved portion 30 is connected to an end portion of the first portion 20 on a side opposite to the terminal block 10. The second portion 40 extends from the curved portion 30 toward the +X direction side (first side in the second direction). The bolt fastening hole 43c is formed in the second portion 40. The curved portion 30 is formed in a curved shape protruding toward the -X direction side (second side in the second direction) with respect to the first portion 20.

Here, as described above, if there is a gap S between the bus bar 2 and the fastening object 90 at the time of fastening the bus bar 2 (see FIGS. 5 and 6), a tensile force in the Z direction acts on the bus bar 2 in order to fill this gap S. In the present embodiment, as described above, the curved portion 30 of the bus bar 2 is formed in a curved shape protruding toward the -X direction side with respect to the first portion 20. With such a shape, the rigidity of the curved portion 30 in the Z direction is reduced, and the curved portion 30 easily extends in the Z direction. By such an action, the curved portion 30 can be extended in the Z direction while dispersing stress applied to the curved portion 30, and the gap S between the bus bar 2 and the fastening object 90 can be filled. In this way, stress concentration in the curved portion 30 can be suppressed. Therefore, strength reduction of the bus bar 2 due to stress concentration at the time of bolt fastening can be suppressed. Note that in FIGS. 5 and 6, the shape of the bus bar 2 before deformation is illustrated with solid lines, and the shape of the bus bar 2 after deformation is illustrated with two-dot chain lines.

In the present embodiment, the curved portion 30 is smoothly connected to the first portion 20 and the second portion 40. With such a configuration, when the curved portion 30 extends, stress generated at a boundary between the curved portion 30 and the first portion 20 and stress generated at a boundary between the curved portion 30 and the second portion 40 can be dispersed. Therefore, strength reduction of the bus bar 2 due to stress concentration at the time of bolt fastening is further suppressed.

In the present embodiment, the first surface 31 on the -X direction side of the curved portion 30 extends from the second surface 41 of the second portion 40 on a side opposite to the terminal block 10 in the Z direction toward the terminal block 10 side in the Z direction. With such a configuration, it is possible to prevent the curved portion 30 from contacting the counterpart fastening object 90 before the second portion 40 at the time of bolt fastening. Therefore, it is possible to prevent extension of the curved portion 30 in the Z direction from being hindered by the fastening object 90 at the time of bolt fastening.

In the present embodiment, groove portions 34 having a curved shape when viewed from the Z direction are formed at both end edges of the curved portion 30 in the Y direction (third direction). With such a configuration, when the curved portion 30 extends at the time of bolt fastening, extension of the curved portion 30 occurs along the groove portions 34, and as shown in FIG. 6, stress F is dispersed radially along the groove portions 34. Therefore, strength reduction of the bus bar 2 due to stress concentration at the time of bolt fastening is further suppressed.

In the present embodiment, the curved portion 30 has the bending starting portion 32 and the curved main body portion 33. The bending starting portion 32 is connected to the first portion 20. The bending starting portion 32 is positioned on the -X direction side while being away from the first portion 20 toward the Z direction. The curved main body portion 33 connects the bending starting portion 32 and the second portion 40. The groove portions 34 are formed in the curved main body portion 33. Here, extension of the curved portion 30 occurs with the bending starting portion 32 as a starting point. For this reason, if the groove portions 34 are formed in the bending starting portion 32, there is a possibility that extension of the curved portion 30 may be hindered. According to the above configuration, since the groove portions 34 are formed in the curved main body portion 33, the curved portion 30 can extend favorably in the Z direction while dispersing stress at the groove portions 34.

In the present embodiment, the two groove portions 34 are formed in the same shape. According to such a configuration, stress F can be uniformly dispersed at both end edges of the curved portion 30 in the Y direction. Therefore, since deviation of stress F is further suppressed, strength reduction of the bus bar 2 due to stress concentration at the time of bolt fastening is further suppressed.

### Modification examples

Next, some modification examples will be described. Note that configurations other than those described below in each modification example are the same as the configurations of the above-described embodiment.

In the above-described embodiment, a case where three bus bars 2 are provided in one bus bar unit 1 has been described, but the embodiment is not limited thereto. The number of bus bars 2 provided in one bus bar unit 1 can be appropriately changed. Also, the plurality of bus bars 2 do not have to be all formed in the same shape.

In the above-described embodiment, it has been assumed that the two groove portions 34 formed in the bus bar 2 have the same shape, but the embodiment is not limited thereto. The shapes of the two groove portions 34 may be different.

Several embodiments and modification examples have been described above. However, the embodiments and the modification examples are not limited to the examples described above.

For example, a plurality of embodiments may be implemented in combination with each other. The above-described embodiments can be implemented in various other forms, and various additions, omissions, substitutions, and modifications can be performed without departing from the gist of the disclosure.

### Reference Signs List

1 Bus bar unit
2 Bus bar
2a Bus bar side surface
10 Terminal block
11 Flange portion
11a End surface
12 Fixing portion
12a Fastening hole
13 Side wall portion
20 First portion
30 Curved portion
31 First surface
32 Bending starting portion
33 Curved main body portion
34 Groove portion
34a Center
34b First end
34c Second end
35 Constricted portion
35a Minimum width portion
40 Second portion
41 Second surface
42 Connection portion
43 Fastening portion
43a Edge portion
43b Corner portion
43c Bolt fastening hole
50 Third portion
60 Fourth portion
90 Fastening object
91 Bolt 91a Head portion S Gap

What is claimed is:

1. A bus bar unit comprising:
a terminal block; and
a bus bar provided integrally with the terminal block,
wherein the bus bar has:
a first portion extending from the terminal block in a first direction,
a curved portion connected to an end portion of the first portion on a side opposite to the terminal block, and
a second portion extending from the curved portion to a first side in a second direction intersecting the first direction and in which a bolt fastening hole is formed, and
wherein the curved portion is formed in a curved shape protruding toward a second side in the second direction with respect to the first portion.

2. The bus bar unit according to claim 1, wherein
the curved portion is smoothly connected to the first portion and the second portion.

3. The bus bar unit according to claim 1, wherein
a first surface of the curved portion on the second side in the second direction extends from a second surface of the second portion on a side opposite to the terminal block in the first direction toward the terminal block side in the first direction.

4. The bus bar unit according to claim 1, wherein
a groove portion having a curved shape when viewed from the second direction is formed at both end edges of the curved portion in a third direction intersecting the first direction and the second direction.

5. The bus bar unit according to claim 4, wherein
the curved portion has:
a bending starting portion connected to the first portion and positioned on the second side in the second direction while being away from the first portion in the first direction, and
a curved main body portion connecting the bending starting portion and the second portion, and
wherein the groove portion is formed in the curved main body portion.
